(19) United States
(12) Patent Application Publication
(10) Pub. No.: US 2004/0248753 A1
(43) Pub. Date: Dec. 9, 2004

(54) Means for removing of paint from object

(76) Inventors: Kjell Karlsson, Molndal (SE); Hans Magnusson, Kallered (SE)

Correspondence Address: Orum & Roth, 53 West Jackson Boulevard, Chicago, IL, 60604, US

(21) Appl. No.: 10/488,278

(22) PCT Filed: Sep. 2, 2002
(86) PCT No.: PCT/SE02/01552

(30) Foreign Application Priority Data
Aug. 31, 2001 (SE) 0102905-7

(51) Int. Cl. C11D 1/00

(52) U.S. Cl. 510/203

(57) ABSTRACT

The present invention relates to a means for the simple and environmentally friendly removal of, for example, paint, varnish, adhesive and rubber from objects without a negative effect on the environment, and which significantly increases the applicability of the means and in particular its stability at higher temperatures. The means in accordance with the invention contains N-methyl-2-pyrrolidone with the addition of a product of the reaction between an aliphatic amine and an alkaline salt of unsaturated fatty acids and water and/or aliphatic alcohols. The invention also relates to the use of the means in question.

The present invention relates to means for removing paint, varnish, rubber, adhesive and plastic or similar on objects.

Chlorinated solvents, such as methylene dichloride and trichloroethylene, have been used in industry for the aforementioned purpose for some considerable time.

It is an established fact that these substances are carcinogenic and cause damage to the central nervous system. They also contribute to acidification in the environment.

Large amounts of paints of the two-component type are used today in conjunction with industrial painting, for example epoxy and isocyanate paints and powder coatings. From time to time defects occur in the painting, which requires removal of the paint and reworking, especially in the case of expensive items and large series. Special fixtures for suspending the goods are also often used in conjunction with painting. These also need to be cleaned of paint regularly. Traditionally, methods for paint removal can be divided into thermal, mechanical and chemical paint removal methods.

The expression thermal denotes burning off at high temperature. This is only possible on components that withstand high temperature and are not sensitive to deformation. Components made of aluminium, for example, are not suitable for the method. The method also generates fumes, which are undesirable from an environmental point of view.

Mechanical paint removal generally involves blasting with various types of blasting medium, for example sand of steel balls. This method is also not suitable for components that are sensitive to mechanical deformation, or where there is a requirement for surface fineness. The method also gives rise to dust, which is undesirable in a painting plant from the point of view of quality.

Chemical paint removal has primarily made use of means based on sodium hydroxide solution or methylene chloride. Sodium hydroxide solution cannot be used on aluminium, since sodium hydroxide solution severely corrodes the metal. It is also not effective on modern, two-component paints or powder coatings. Methylene chloride is a very good paint remover on most substrates and paint materials, especially when used in conjunction with so-called activators such as formic acid. The use of methylene chloride is prohibited in many countries, however, because of its aforementioned environmental characteristics.

Tools and fixtures that require regular cleaning are used for industrial gluing. The glue used is often of the epoxy or polyurethane type.

Moulds and tools that require regular cleaning from rubber residues to ensure their effective function are used in the rubber industry. Methylene chloride in various formulations is used almost exclusively for this cleaning.

A means that is suitable for use for the above-mentioned applications in an effective and environmentally compatible fashion is indicated below as a substitute for chlorinated solvents, primarily methylene chloride, and which contains N-methyl-2-pyrrolidone with the addition of potassium oleate and water.

It is important for the means to exhibit good applicability and in particular stability at high temperatures.

Described in the article, “Paint remover free of chlorinated solvents” in Research Disclosure March 1987, page 176, is a means for the removal of paint that is free from chlorinated solvents. This means contains N-methyl-2-pyrrolidone ethanolamine potassium oleate. The means also includes DBE (dibasic ester solvent) and Aromatic 150 as solvents.

Previously disclosed in JP 6313197 is a cleaning agent for the effective removal of oil contamination inter alia. The means contains N-methyl-2-pyrrolidone, an aliphatic amine such as ethylenediamine and water as solvents.

The aforementioned previously disclosed means does not, however, exhibit any addition of a product of the reaction between an aliphatic amine and an alkaline salt, which significantly increases the effectiveness of the means. Also, this cannot be regarded as appropriate for a person skilled in the art to apply.

The principal object of the present invention is thus, in the first instance, to increase the aforementioned characteristics of the means and likewise to make it environmentally and technically effective.

The aforementioned object is achieved by means of a means in accordance with the present intention, which is characterized essentially in that the means contains n-methyl-2-pyrrolidone and/or one or more solvents of the type dibasic ester, carbonate or dimethyl sulphoxide, with the addition of a product of the reaction between an aliphatic amine and an alkaline salt of unsaturated fatty acids and water and/or aliphatic alcohols.

It is an established fact that N-methyl-2-pyrrolidone, which is shortened in everyday usage to NMP, can be used to remove paint and varnish from components made of wood or metal, for example. NMP has low surface tension and penetrates the layer of paint, causing it to swell and release from the substrate, after which it can be removed easily, for example by brushing or spraying with water. However, pure NMP is only suitable for use with “simpler” paint materials, such as alkyd or acrylic paints. The way in which the base material is treated is also very important. A chromated aluminium surface or a phosphated steel surface will thus give very good adhesion to the paint material, which to a high degree makes its removal difficult. It has emerged in the course of laboratory tests and practical operating tests that the addition of small quantities of potassium oleate significantly improves the ability of NMP to penetrate the paint layer and to bring about the release of the aforementioned layer from chromated or phosphated substrates.

The best function is obtained at an elevated temperature within the range of 80-110° C., appropriately in a thermostatically controlled tank. Residues of adhesive and rubber can also be removed by this method. Potassium oleate is the potassium salt of oleic acid oleic acid belongs to the group of unsaturated fatty acids, i.e. they contain one or more double bonds. Characteristic of these substances is their ability to oxidize readily at higher temperatures. Potassium oleate thus oxidizes at an elevated temperature to form acid products, nonanoic and azelaic acid, which significantly impair the stability and function of the means. Countless commercially available, so-called oxidation inhibitors have been tested in an effort to prevent the aforementioned oxidation, but without giving the intended result. It has emerged in the course of laboratory tests and in practical operating tests, however, that the addition of a small quantity of water, which is not normally desirable in NMP formulations, produces the desired positive effect. The water content should preferably be between 1.0 and 15%, calculated in relation to the quantity of NMP.

### EXAMPLES

One way of measuring the acidification of a cleaning fluid in accordance with the foregoing is to measure the consumption of 0.1-n sodium hydroxide solution per 5 ml of the sample by electrometric titration to pH 9.4. This consumption in ml is referred to as the acid value.

One sample that was aged at 100° C. for 1000 hours and contained 3% of potassium oleate had an acid value=8.0 and a non-existent function after completion of the test.

Another sample that was aged as described above, and which, in addition to 3% of potassium oleate, also contained 6% of water, had an acid value=2.5 and a satisfactory function after completion of the test. The appropriate level of potassium oleate preferably lies between 0.2 and 6%, calculated in relation to the quantity of N-methyl-2-pyrrolidone.

It has emerged in the course of practical tests that the addition of a small quantity of water to a solution of NMP and potassium oleate significantly shortens the process time for the removal of paint, adhesive and rubber from components made of metal or plastic.

A means in accordance with the present invention solves the aforementioned problems simply and effectively, as well as in an environmentally friendly fashion.

The invention under consideration serves as a complement to the invention in accordance with Swedish Patent Application No. 0000687-4, “Means for cleaning”. The aforementioned patent application relates to a means for cleaning objects, which to a considerable extent contain N-methyl-2-pyrrolidone (NMP), an alkaline salt of unsaturated fatty acids and water as mentioned above.

A means containing these components in accordance with the patent application constitutes an effective cleaning agent for the aforementioned purpose. It has nevertheless emerged in the course of practical experiments that the applicability and above all the stability of the means at higher temperatures are increased considerably if the aforementioned alkaline salt of unsaturated fatty acids is allowed to react with an aliphatic amine, in conjunction with which the unsaturated fatty acid forms a saturated compound containing an amine group. This compound is a particularly powerful surfactant in this context and is water-soluble, which facilitates the dissolution of the means in NMP to a considerable degree.

The amines tested include ethylenediamine and ethanolamine, of which the latter is preferred because of its better stability and its better environmental characteristics.

Potassium oleate may be mentioned as an example of an alkaline salt of an unsaturated fatty acid. If the aliphatic amine consists of ethanolamine, the reaction between these substances can be described with the following reaction formula:

CH₃(CH₂)—CH═CH—(CH₂)—COOK+NH₂ (CH₂)₂OH—>

CH₃ (CH₂)—CH—NH(CH₂)₂OH—CH₂—(CH₂);—COOK

The reaction is executed in the liquid phase at room temperature, which facilitates its execution.

A surplus of aliphatic amine, estimated as at least 100%, is required to ensure that an acceptable exchange of reaction product is achieved within a reasonable period at room temperature.

The aforementioned aliphatic alcohols consist of polyhydric alcohols, and they are present at a level of between 0.1 and 50%.

When utilizing a product of the reaction between potassium oleate and ethanolamine, and if the aforementioned reaction product has a molecular weight of 364 and the total formula C₂₀H₃₈O₂NK.

The invention is naturally not restricted to the above description. Modifications are possible, especially in respect of the nature of the means, or by the use of equivalent technology, without departing from the area of protection afforded to the invention, as defined in the Patent claims.

1-13. (cancelled)

14. Substance for removing paint, varnish, rubber, adhesive, plastic, and similar materials, comprising:
N-methyl-2-pyrrolidone and
A solvent selected from the group consisting of dibasic ester, carbonate, and dimethyl sulphoxide, and a product of a reaction between an aliphatic amine and an alkaline salt of unsaturated fatty acids and water and aliphatic alcohols.

15. Substance according to claim 14, wherein the alkaline salt is potassium oleate.

16. Substance according to claim 14, wherein the aliphatic amine is ethanolamine.

17. Substance according to claim 16, wherein the ethanolamine is added at a surplus of at least 100% of the stoichiometric requirement.

18. Substance according to claim 14, further comprising a product of the reaction between potassium oleate and ethanolamine, the reaction product having a reaction weight of 364 and having a chemical formula C₂₀H₃₈H₂NK.

19. Substance according to claim 14, wherein the quantity of a product of the reaction between an alkaline salt of an unsaturated fatty acid and ethanolamine is between 0.1% and 10.0%, calculated in relation to the quantity of N-methyl-2 pyrrolidone.

20. Substance according to claim 14, wherein the aliphatic amine is ethylenediamine.

21. Substance according to claim 20, wherein ethylenediamine is added at a surplus of at least 100% of the stoichiometric requirement.

22. Substance according to claim 20, wherein the quantity of a product of the reaction of a product of the reaction between an alkaline salt of an unsaturated fatty acid and ethylenediamine is between 0.1% and 10.0%, calculated in relation to the quantity of N-methyl-2-pyrrolidone.

23. Substance according to claim 14, wherein the water content is between 1% and 50% calculated in relation to the quantity of N-methyl-2-pyrrolidone.

24. Substance according to claim 14, wherein the aliphatic alcohols are polyhydric alcohols, and are present at a level of between 0.1% and 50.0%.

25. Substance according to claim 14, wherein the substance is maintained at an elevated temperature between 80° C. and 110° C.

26. Method of removing undesired powder coatings, paint, and similar material, from objects prior to refinishing comprising the step of applying the substance according to claim 1 to the object, and then removing the substance along with the undesired material.

27. Substance for removing paint, varnish, rubber, adhesive, plastic, and similar materials, comprising:
N-methyl-2-pyrrolidone or
A solvent selected from the group consisting of dibasic ester, carbonate, and dimethyl sulphoxide, and a product of a reaction between an aliphatic amine and an alkaline salt of unsaturated fatty acids and water and aliphatic alcohols.

28. Substance according to claim 15, wherein the aliphatic amine is ethanolamine.

29. Substance according to claim 15, further comprising a product of the reaction between potassium oleate and ethanolamine, the reaction product having a reaction weight of 364 and having a chemical formula C₂₀H₃₈O₂NK.

30. Substance according to claim 15, wherein the quantity of a product of the reaction between an alkaline salt of an unsaturated fatty acid and ethanolamine is between 0.1% and 10.0%, calculated in relation to the quantity of N-methyl-2 pyrrolidone.

31. Substance according to claim 15, wherein the aliphatic amine is ethylenediamine.

32. Substance according to claim 21, wherein the quantity of a product of the reaction of a product of the reaction between an alkaline salt of an unsaturated fatty acid and ethylenediamine is between 0.1% and 10.0%, calculated in relation to the quantity of N-methyl-2-pyrrolidone.

33. Substance according to claim 15, wherein the water content is between 1% and 50% calculated in relation to the quantity of N-methyl-2-pyrrolidone.
